(19) United States
(12) Patent Application Publication
(10) Pub. No.: US 2020/0068822 A1
(43) Pub. Date: Mar. 5, 2020

(54) METHOD OF GROWING SEEDS

(71) Applicant: Avocet IP Limited, Berwick Upon Tweed, Northumberland (GB)

(72) Inventor: James Robert JENNINGS, Yarm, North Yorkshire (GB)

(21) Appl. No.: 16/466,117

(22) PCT Filed: Dec. 4, 2017
(86) PCT No.: PCT/EP2017/025351

§ 371 Date: Jun. 3, 2019

(30) Foreign Application Priority Data
Dec. 2, 2016 (GB) 1620561.9

(51) Int. Cl. A01G 31/06; A01C 1/02; A01G 9/24

(52) U.S. Cl. CPC A01G 31/06; A01G 9/24; A01C 1/02

(57) ABSTRACT

A method of growing seeds in a hydroponics apparatus to provide animal feed includes trays for receiving seeds, an environmental control arrangement for controlling a temperature and humidity of the trays, and a nutrient solution supply arrangement for providing a nutrient solution to the seeds wherein the method includes:
(i) preparing the seeds by removing loose chaff, remnants of husks, and broken seeds;
(ii) exposing the prepared seeds to gaseous ozone in either a) a concentration in a range of 5-10 p.p.m.v. for a period in a range of 50-60 minutes or b) a concentration in the range of 10-20 p.p.m.v. for a period in a range of 1-30 minutes, in a relative humidity range of 40%-95%, and at an ambient temperature range of 12° C.-28° C.; and
(iii) growing the exposed prepared seeds to provide grown plant material for use in producing the animal feed.

### TECHNICAL FIELD

The present disclosure relates to methods of growing seeds in controlled environment. In particular, the present disclosure relates to a method of growing seeds in a hydroponics apparatus to provide animal feed.

### BACKGROUND

Livestock is typically conventionally allowed to graze in pasture and similar terrain, and fed on silage in winter, wherein the silage is generated from harvested plant material, by way of a fermentation process. The silage provides the livestock with sufficient nutrition to survive, it is not particularly exciting for the livestock to eat, that enjoy fresh plant material with exciting aroma and texture; this is important with regards to animal welfare.

Although intensively farmed animals are known, for example as in poultry industry, such techniques are not suitable for other types of animals than poultry. Therefore, there arises a need to provide improved livestock feed production apparatus for supporting advanced highly productive forms of agriculture. Of particular importance is to ensure that cattle receive sufficient roughage for their digestive systems to function in an efficient manner, which is also conducive to good animal welfare.

A problem encountered when growing seeds intensively for generating livestock feed, as well as encountered when producing conventional animal feed such as silage, is mould growth. Mould growth metabolites are potentially toxic to animals consuming feedstock that contains mould, especially to nervous systems of the livestock.

Attempts have been made to treat mould growth with chemicals such as chlorine, chlorine dioxide, bleach, bromine compounds and similar, but these chemicals tend to damage seeds, roots and shoots, resulting in stunted plant growth and reduce plant matter yield at time of harvesting.

### SUMMARY

The present disclosure seeks to provide an at least partial solution to the aforementioned problem of mould growth in intensive farming systems for growing feed for livestock.

According to an aspect of the present disclosure, there is provided a method of growing seeds in a hydroponics apparatus to provide animal feed, wherein the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein the method includes:

(i) preparing the seeds by removing loose chaff therefrom, and removing remnants of husks and broken seeds;
(ii) exposing the prepared seeds from (i) to gaseous ozone in a sealed gaseous exposure chamber, wherein the ozone is provided to the prepared seeds in either a) a concentration in a range of 5 p.p.m.v. to 10 p.p.m.v. for a period in a range of 50 minutes to 60 minutes or b) a concentration in the range of 10 p.p.m.v. to 20 p.p.m.v. for a period in a range of 1 minute to 30 minutes, in a condition of relative humidity in a range of 40% to 95%, and at an ambient temperature in a range of 12° C. to 28° C.; and
(iii) providing exposed prepared seeds from (ii) to the plurality of elongate trays for growing the exposed prepared seeds to provide grown plant material for use in producing the animal feed.

The present disclosure is of advantage in that method of growing seeds in a hydroponics apparatus provides plant growth material of high quality by reducing chances of mould growth during germination of the seeds.

Optionally, in (ii) the seeds may be exposed to gaseous ozone for periodic intervals of time, for example such that the period for which ozone is provided to the prepared seeds is the sum total of the periodic intervals of time.

Optionally, in (ii), the method includes maintaining the condition of relative humidity in a range of 50% to 85%.

Optionally, in (ii), the method includes maintaining the ambient temperature in a range of 15° C. to 25° C.

Optionally, in (iii), the method includes:

(iv) operating the environmental control arrangement to maintain the nutrient solution and an environment of the trays at a temperature in a range of 19° C. to 25° C.; and
(ii) providing the plurality of trays in operation with a substantially similar flow rate of the nutrient solution.

Optionally, in (iii), the method includes disposing the plurality of trays in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

Optionally, in (iii), the method includes creating a light-excluded environment for the seeds to germinate to develop roots and shoots.

Optionally, in (iii), the method includes using a controllable lighting arrangement for selectively illuminating sub-portions of the seeds on the trays for providing differentiated growth of the seeds along the plurality of trays.

Optionally, in (iii), the method includes mounting the plurality of trays upon a moveable carousel for allowing for automated loading of seeds onto the plurality of trays and automated off-loading of their germinated seeds, and their roots and shoots, onto a carrier for removal for processing to generate the animal feed.

Optionally, in (iii), the method includes providing gaseous fumigation of the seed during growing of the seed in the substantially light-excluded environment.

Optionally, in (iii), the method includes arranging for the plurality of trays to have a length-to-width ratio in a range of 3:1 to 10:1.

Optionally, the method includes providing the plurality of trays with an actuation arrangement for selectively flexing regions of the trays for sweeping ponding of nutrient solution occurring therein along a length of the trays.

Optionally, in (iii), the method includes arranging the trays in one or more vertical stacks, wherein planes of the trays for receiving the seeds are substantially mutually parallel.

According to a second aspect, there is provided a hydroponics apparatus including a plurality of elongate trays for receiving prepared seeds, an environmental control arrangement for controlling in operation a temperature and humidity of the plurality of elongate trays, a nutrient solution supply arrangement for providing a nutrient solution to the seeds on the plurality of trays, and a fumigation arrangement for fumigating the prepared seeds during growth, wherein the apparatus is operable to employ the aforementioned method of growing seeds to provide animal food.

It will be appreciated that features of the disclosure are susceptible to being combined in various combinations without departing from the scope as defined by the appended claims.

Throughout the specification, where ozone concentration is referred to in p.p.m.v., this is parts per million by volume at STP.

### DESCRIPTION OF THE DIAGRAMS

Embodiments of the present disclosure will now be described, by way of example only, with reference to the following diagrams wherein:

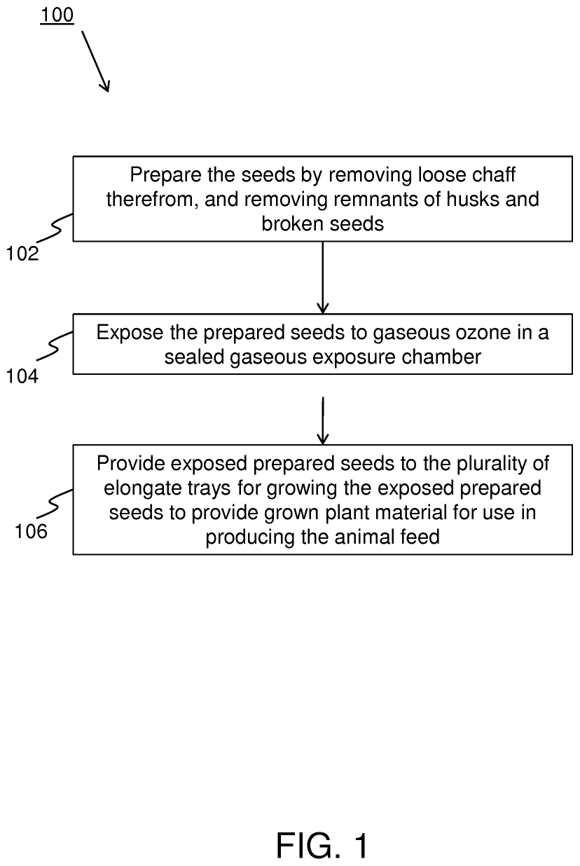

FIG. 1 is a flow chart of method for growing seeds in a hydroponics apparatus to provide animal feed, in accordance with an embodiment of the present disclosure; and

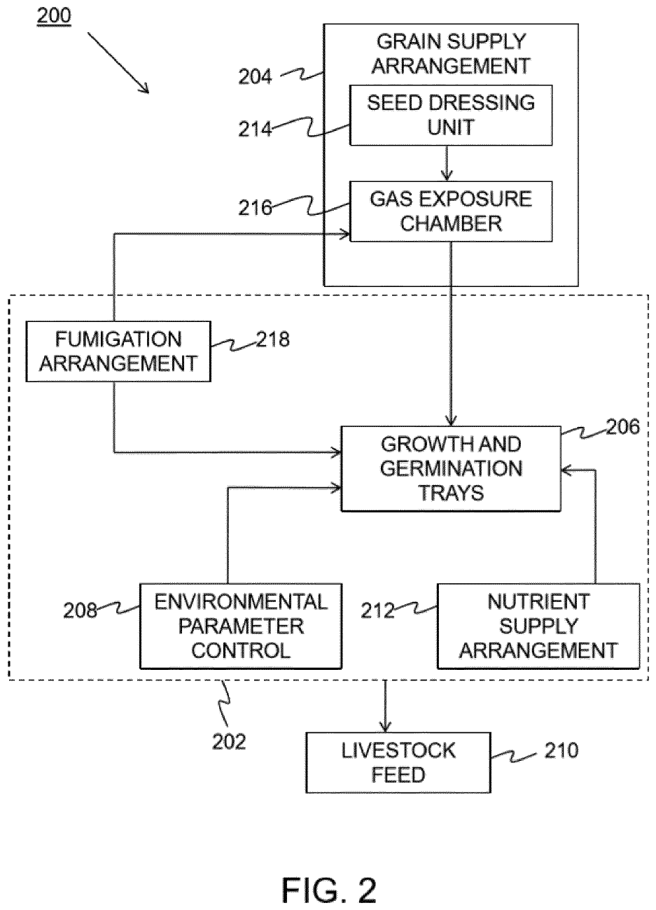

FIG. 2 is a block diagram of an environment including a hydroponics apparatus illustration of a method of operating the hydroponics apparatus operable to employ the method of FIG. 1.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with highly efficient technology for producing feed for livestock in a manner that is more efficient than conventional known farming techniques, and provides feed that is more enjoyable and nutritious for livestock to consume.

FIG. 1 is a flow chart of method 100 for growing seeds in a hydroponics apparatus to provide animal feed, in accordance with an embodiment of the present disclosure. At step 102 the flowchart 100 initiates. At the step 102, seeds are prepared by removing loose chaff therefrom, and removing remnants of husks and broken seeds. At step 104, prepared seeds received from step 102 are exposed to gaseous ozone in a sealed gaseous exposure chamber. The concentration of ozone to which the seeds are exposed may be in a range of 5 p.p.m.v. to 10 p.p.m.v. for a period in a range of 50 minutes to 60 minutes, in a condition of relative humidity in a range of 40% to 95%, and at an ambient temperature in a range of 12° C. to 28° C. Alternatively, the seeds may be exposed to gaseous ozone at a concentration in the range of 10 p.p.m.v. to 20 p.p.m.v. This ozone exposure may be implemented for a duration of 1 minute to 30 minutes.

At step 106, exposed prepared seed received from step 104 are provided to a plurality of elongated trays of a hydroponics apparatus for growing the exposed prepared seeds to provide grown plant material for producing the animal feed.

At step 102, the loose chaff from the seeds may be removed by at least one of threshing, milling, pounding and so forth. Further, the remnants of husks may be removed by winnowing, sieving and so forth. At step 102, the broken seeds may be removed by shifting, sieving and so forth of the seeds after removing the loose chaff and the remnants of husks.

At step 104, the prepared seeds may be exposed to the ozone in a sealed gaseous exposure chamber for removing moulds from the treated seeds.

Optionally, at step 104 the method 100 is operable for maintaining the condition of relative humidity in a range of 50% to 85%. Moreover, the method 100 is operable for maintaining the ambient temperature in a range of 15° C. to 25° C.

In an exemplary embodiment, at step 104 the method 100 may be operable to remove Aspergillus from the prepared seeds by exposing the prepared seeds to the ozone gas. For example, the prepared seeds may be exposed to the ozone gas in periodic intervals. The ozone gas concentration may be in range of 10 p.p.m.v. to 20 p.p.m.v. The ozone exposure may be implemented for a duration of 1 minute to 30 minutes.

In another embodiment, at step 104 the method 100 is operable to remove Aspergillus from the prepared seeds by exposing the prepared seeds to the ozone gas. In this embodiment, the prepared seeds are periodically exposed to the ozone gas. The ozone gas concentration may range between 5 p.p.m.v. to 10 p.p.m.v. and the ozone exposure may be implemented for duration of 50 minutes to 60 minutes. In practice, this embodiment is advantageous in terms of eliminating chances of mould growth during germination of the seeds and resulting to high quality plant growth material.

In an embodiment, the method 100 may be operable for operating an environmental control arrangement for maintaining a nutrient solution required for the growth of the exposed seeds and the elongated trays receiving the exposed seeds at a temperature in a range of 19° C. to 25° C. In present embodiment, the method 100 may be further operable for maintain a substantially similar flow rate of the nutrient solution in the plurality of elongated trays.

In an embodiment, the method 100 may be operable for disposing the plurality of trays in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

In an exemplary embodiment, the method 100 may be operable to tilt the elongated trays at an angle ratio 1:100 to obtained water runoff from a water feed arrangement. Optionally, in different embodiments of the present disclosure the method 100 is operable to tilt the elongated trays in a range of the angle ratio 1:50 to 1:20 for avoidance of ponding.

In an embodiment, the method 100 may be operable to create a light-excluded environment for the seeds to germinate to develop roots and shoots. In this embodiment, the method 100 is operable to control a lighting arrangement for selectively illuminating sub-portions of the seeds on the elongated trays for providing differentiated growth of the seeds along the plurality of trays. For example, controlling energy efficient LEDs of various colours for providing the differentiated growth of the seeds along the plurality of trays.

In an embodiment, the method 100 is operable for mounting the plurality of trays upon a moveable carousel for allowing for automated loading of seeds onto the plurality of trays and automated off-loading of their germinated seeds, and their roots and shoots, onto a carrier for removal for processing to generate the animal feed.

In another embodiment, the method 100 may be operable for providing gaseous fumigation to the exposed seeds during germination in light-excluded environment. In present embodiment, the method 100 may be operable for fumigating the exposed seeds to reduce growth of mould in the plant growth material. The ozone gas may be used temporally periodically in combination with sulphur dioxide and/or chlorine gas for fumigating the supplied grain in response to detection of mould formation upon the supplied grain, its roots and/or shoots.

In an embodiment, the method 100 includes arranging for the plurality of trays to each have a length-to-width ratio in a range of 3:1 to 10:1.

In an embodiment, the method 100 is operable for providing an actuation arrangement for selectively flexing regions of the trays for sweeping ponding of nutrient solution occurring therein along a length of the trays. For example, actuation arrangement may be activated in a sequence along a length of the trays to sweep any ponding along the trays. The actuators may be electromagnetic actuators that are actuated under computer control, although hydraulic actuators can alternatively be employed.

In another embodiment, the method 100 may be operable for arranging the plurality of trays in one or more vertical stacks. In present embodiment, planes of the elongated trays for receiving the seeds from the grain supply arrangement may be substantially mutually parallel.

In another embodiment, the method 100 may be operable for arranging the elongated trays on a vertically rotating carousel and the elongated trays may be pivotable along one of their elongate edges to enable rapid automated emptying of the elongated trays into a collection holder, wherein the germinated grain may be pulverized as aforementioned to provide livestock feed. In present embodiment, the pulverization may only be partial so as to provide the livestock with interesting texture to munch (for example, to provide for roughage for their digestive system).

FIG. 2 is a block diagram of an environment 200 including a hydroponics apparatus 202 operable to employ the method 100 of FIG. 1 for growing seeds to provide animal feed, in accordance with an embodiment of the present disclosure. As shown, the environment 200 includes the hydroponics apparatus 202 and a grain supply arrangement 204 for supplying seeds to the hydroponics apparatus 202.

The hydroponics apparatus 202 includes a plurality of elongated trays 206 for receiving seeds from a grain supply arrangement 204. The hydroponics apparatus 200 also includes an environmental parameter control arrangement 208 operable to control a temperature and humidity of the plurality of elongate trays 206 while growing the feed for livestock 210 and a nutrient solution supply arrangement 212 for providing a nutrient solution to the seeds on the plurality of trays 206. The environment 200 along with the hydroponic apparatus 202 also includes a grain supply arrangement 204 for supplying the seeds to the plurality of elongate trays 206 for growth and germination.

Further, the grain supply arrangement 204 includes a seed dressing unit 214 for the preparing the seeds in order to remove loose chaff and remnants of husks and broken seeds in accordance with the aforementioned step 102 of the method 100. The seed dressing unit 214 is operable to supply the prepared seeds to a sealed gaseous exposure chamber 216 for the exposure to ozone from the fumigation arrangement 218 in accordance with the aforementioned step 104 of the method 100. Further the exposed seeds received from the sealed gaseous exposure chamber are provided to the plurality of elongate trays 206 for growing the exposed prepared seeds in the hydroponics apparatus 202 to provide grown plant material for using in producing the animal feed.

In an embodiment, the sealed gaseous exposure chamber 216 may be operable to provide the ozone gas to the prepared seeds at a prescribed concentration for a prescribed period, for example by use of a programmed dosing apparatus, optionally with a gas analyser.

In an exemplary embodiment, the fumigation arrangement 218 may be operable to periodically fumigate the prepared seeds present in the germination trays 206. In this embodiment, the ozone gas concentration may range between 5 p.p.m.v. to 10 p.p.m.v. and the ozone exposure may be implemented for duration of 50 minutes to 60 minutes. Again, a programmed dosing apparatus may be employed to control the ozone gas concentration. In practice, this embodiment is advantageous in terms of eliminating chances of mould growth during germination of the seeds and resulting to high quality plant growth material.

In another embodiment, the environmental parameter control arrangement 208 may be operable to maintain a condition the exposed seeds at relative humidity in a range of 40% to 95%, and at an ambient temperature in a range of 12° C. to 28° C.

In another embodiment, the fumigation arrangement 218 may remove moulds from roots and shoots of the resulting plant growth material from germination of exposed seeds in the elongated trays 206.

The method of growing seeds and the apparatus provided in the present disclosure may, respectively, include and be configured to maintaining optimum level of carbon dioxide (CO₂) required for photosynthesis of the germinated seeds or fodder. For example, a gas feed arrangement may include one or more sensors for measuring the levels of CO₂ and/or for controlling the release of CO₂, maintaining it a required level or an optimum level of CO₂. The level of CO₂ may be controlled by a gas feed arrangement, or by adjusting one or more parameters of the fodder growth process, for example changes in temperature of operation which would with speed or slow chemical (or bio-chemical) reactions, including the fodder growth rate.

The present disclosure is of advantage in terms of that method of growing seeds in a hydroponics apparatus provides plant growth of high quality by reducing chances of mould growth during germination of the seeds.

Additionally, the present disclosure is advantageous in terms that it is a better technique of farming which provides better quality and yield of the crop than traditional farming by utilizing lesser resources like water, nutrients, and so forth.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of growing seeds in a hydroponics apparatus to provide animal feed, wherein the hydroponics apparatus includes a plurality of elongate trays for receiving seeds, an environmental control arrangement for controlling in operation a temperature and humidity of the plurality of elongate trays, and a nutrient solution supply arrangement for providing a nutrient solution to the seeds on the plurality of trays, wherein the method includes:
(i) preparing the seeds by removing loose chaff therefrom, and removing remnants of husks and broken seeds;
(ii) exposing the prepared seeds from (i) to gaseous ozone in a sealed gaseous exposure chamber, wherein the ozone is provided to the prepared seeds in either a) a concentration in a range of 5 p.p.m.v. to 10 p.p.m.v. for a period in a range of 50 minutes to 60 minutes or b) a concentration in the range of 10 p.p.m.v. to 20 p.p.m.v. for a period in a range of 1 minute to 30 minutes, in a condition of relative humidity in a range of 40% to 95%, and at an ambient temperature in a range of 12° C. to 28° C.; and
(iii) providing the exposed prepared seeds from (ii) to the plurality of elongate trays for growing the exposed prepared seeds to provide grown plant material for use in producing the animal feed.

2. A method of claim 1, wherein, in (ii), the method includes maintaining the condition of relative humidity in a range of 50% to 85%.

3. A method of claim 1, wherein, in (ii), the method includes maintaining the ambient temperature in a range of 15° C. to 25° C.

4. A method of claim 1 wherein, in (iii), the method includes:
(iv) operating the environmental control arrangement to maintain the nutrient solution and an environment of the trays at a temperature in a range of 19° C. to 25° C.; and
(ii) providing the plurality of trays in operation with a substantially similar flow rate of the nutrient solution.

5. A method of claim 1, wherein, in (iii) the method includes disposing the plurality of trays in operation so that the elongate axis of each tray is at a tilted angle in operation with respect to a horizontal plane, wherein the tilted angle is of a magnitude for allowing run-off of the nutrient solution and avoidance of ponding of the nutrient solution along the plurality of elongate trays.

6. A method of claim 1, wherein, in (iii), the method includes creating a light-excluded environment for the seeds to germinate to develop roots and shoots.

7. A method of claim 6, wherein, in (iii), the method includes using a controllable lighting arrangement for selectively illuminating sub-portions of the seeds on the trays for providing differentiated growth of the seeds along the plurality of trays.

8. A method of claim 1, wherein, in (iii), the method includes mounting the plurality of trays upon a moveable carousel for allowing for automated loading of seeds onto the plurality of trays and automated off-loading of their germinated seeds, and their roots and shoots, onto a carrier for removal for processing to generate the animal feed.

9. A method of claim 1, wherein, in (iii), the method includes providing gaseous fumigation of the seed during growing of the seed in the substantially light-excluded environment.

10. A method of claim 1, wherein, in (iii), the method includes arranging for the plurality of trays to each have a length-to-width ratio in a range of 3:1 to 10:1.

11. A method of claim 1, wherein the method includes providing the plurality of trays with an actuation arrangement for selectively flexing regions of the trays for sweeping ponding of nutrient solution occurring therein along a length of the trays.

12. A method of claim 1, wherein, in (iii), the method includes arranging the trays in one or more vertical stacks, wherein planes of the trays for receiving the seeds are substantially mutually parallel.

13. A hydroponics apparatus including a plurality of elongate trays for receiving prepared seeds, an environmental control arrangement for controlling in operation a temperature and humidity of the plurality of elongate trays, a nutrient solution supply arrangement for providing a nutrient solution to the seeds on the plurality of trays, and a fumigation arrangement for fumigating the prepared seeds during growth, wherein the apparatus is operable to employ a method as claimed in claim 1 for producing animal feed.
